(19) United States
(12) Patent Application Publication
(10) Pub. No.: US 2012/0188208 A1
(43) Pub. Date: Jul. 26, 2012

(54) INTERFACE ENHANCEMENT COMPONENT FOR USE WITH ELECTRONIC TOUCH-SCREEN DEVICES

(75) Inventor: Nathaniel Jon BREITBACH, Fairfax, VA (US)

(73) Assignee: Breit Solutions, LLC, Fairfax, VA (US)

(21) Appl. No.: 13/353,435

(22) Filed: Jan. 19, 2012

Related U.S. Application Data
(60) Provisional application No. 61/434,483, filed on Jan. 20, 2011.

(51) Int. Cl. G06F 3/033

(52) U.S. Cl. 345/179

(57) ABSTRACT

An interface enhancement component is described for use with touch devices. This component consists of a thin, rigidity increasing, generally flat-shaped support structure, no larger than the size of the user interface directly attached to the component. Disclosed embodiments provide a slight protrusion extending from the support structure that consists of a gradually rising bell-shaped structure that allows for accuracy of input and is angled in relation to the support structure for optimal application. The material comprising this component will provide for functionality regardless of the type of touch technology currently in existence, including capacitive and resistive technology, it may serve to increase the rigidity of the user interface where applicable, and it may also provide for additional playability depending on the application.

### CROSS-REFERENCE TO RELATED DOCUMENTS

This application claims priority to provisional patent application No. 61/434,483 entitled “Interface Enhancement Component For Use With Electronic Touch-Screen Devices,” filed Jan. 20, 2011, the entire disclosure of which is hereby incorporated by reference herein.

### BACKGROUND

1. Field of the Invention

The present invention is in the field of interfacing with electronic devices. More particularly, the present invention is in the field of touch device technology. Even more particularly, the present invention is in the field of components used with a user interface and an electronic touch device.

2. Related Art

The current field consists of a multitude of solutions for the manipulation of software on a computing device via resistive or capacitive touch device technology. The focus of these additional components has been to increase accuracy of input through the reinvention of software programs, “pencil-like” tools or unique embodiments of traditional computing input devices, such as the keyboard and mouse. Noted in the prior art, such tools can be tiresome to use over a prolonged period of time. In addition, there is always the possibility of misplacing or losing the tools, and they create the necessity for additional skill development or knowledge of software systems; or they require the user to alternately handle an object as needed, further restricting use of the user interface to the function of the specific object. The software solutions for touch devices seek to make using the default user interface as functional as possible. The deficiencies related to these software solutions result from the virtually unlimited physical differences in the physical form of the user interface in terms of shape, size and skill, which make the generalization of specialized software solutions less effective.

There are a few noteworthy examples in the prior art that do a sufficient job of recognizing the traditional problems and typical solutions related to the prior art. Patent application US 2005/0093835, entitled “Finger Tip Stylus for handheld computing devices” issued to John Renato Mortarelli, dated May 5, 2005, seeks to address the prior art by temporarily affixing the “pencil-like” device to the fingertip. The problem is the design assumes that the “pencil-like” device addresses the core deficiency of the relationship between the fingertip—in this instance, the hard surface of the touch device, and the software used to accept input. The “pencil-like” device in fact is not the core deficiency, and therefore the solution proposed by Mortarelli further restricts the use of the finger to the specific function of the “pencil-like” device. The resulting solution does not solve the underlying problem of enhancing the user interface to be more in tune with how interaction with touch device technology naturally occurs.

In design patent D618,243, entitled “Thumb-Mounted Stylus” issued to Randall E. Chamblin, dated Jun. 22, 2010, Chamblin depicts a design that provides additional flexibility in terms of placement. However, Chamblin reverts back to some of the problems of the prior art, notably the need to carry a component that could be lost; the need to remove the component to perform other more general functions; and the creation of a social hurdle in terms of wearing a cumbersome device on the finger.

In Patent Application US 2007/0013681, entitled “Ambidextrous Multi-Function Finger Adapter” issued to Joseph C. Chou, dated Jan. 18, 2007, Chou describes a finger device that can be worn on either hand, with several stylus tips in varying positions throughout the support structure surface of the device. The core deficiency with this device, along with most of the prior art, is that the position of the stylus, or “pencil-like” device, is made for the user. These solutions simply remove the uniqueness of how each individual utilizes his or her body to interface with the touch device. Much of the prior art similarly seeks to reinvent the “pencil-like” solution, or other traditional input methods, in all forms trading one deficiency for another.

The development of touch device technology has yielded the advancement and increased use of touch-screen devices. The touch sensitivity of the average touch-screen device may result from a layer of capacitive material that adorns its surface. This capacitive material stores an electrical charge that is distributed uniformly across the screen when not in use. When a digit, such as a finger or thumb, is pressed against the capacitive material screen, some of the charge is transferred to the user's skin, thereby causing the charge on the capacitive layer to decrease in the spot that is touched. It is this change that (a) lets the device know that it has been touched and (b) tells the whereabouts of the digit being applied against the screen.

While the capacitive layer may work well in many situations, it does not respond to a pen, a stylus or any other pointing instrument, for example. This is because these items do not conduct electricity and, therefore, serve to act only as a barrier that prevents a user's skin from altering the charge on the screen. The same would apply if a user were, for example, wearing a normal pair of gloves. This would mean that on a cold, wet and windy winter's day, a user would have to either keep their gloves off or remove the clothing items, thereby exposing one or more digits to the weather elements in order to make calls, send e-mails, instant messages, texts and tweets, and play music, etc.

While nearly all modern touch-screen devices employ the kind of capacitive technology described above, some (typically older devices) rely on resistive technology instead. Resistive touch screens generally consist of two extremely thin metallic layers overlaid by a substrate, such as a sheet of glass. When a user touches the glass, the two underlying metallic layers are pressed together, causing the device to register a touch. So, unlike capacitive touch screens, the touch screens of resistive-technology devices are pressure sensitive, which means that they can be manipulated with any object whatsoever—including, for example, fingers, a stylus, a pen, etc.

However, some individuals may find it difficult to simply register a single point coinciding with a designated area of the touch-screen device. This may be due to the size of the user digit contacting too much surface area of the touch-screen device, thereby registering too many points along the touch screen. In addition, repetitive manipulation of a user's fingers to exacting positions during use of the touch screen may become tiresome and, in some case, run the risk of developing one or more muscle complications from repetitive movements. However, as outlined above, using tools can be tiresome over a prolonged period of time and may risk the possibility of the tools being misplaced or lost. Also, employing the use of an additional tool, such as a stylus or a pen, can create the necessity for additional skill development or knowledge of software systems, or require the user to alternately handle an object as needed, further restricting use of the user interface to the function of the specific object.

Accordingly, a need exists for an improved adaptive functionality to increase the accuracy of input and response of touch-screen devices. A need also exists for reducing or eliminating user fatigue during input and to overcome previous obstacles of the prior-art devices, including, for example, those related to shape, size and skill, which may make the generalization of applied specialized software solutions less effective.

### SUMMARY OF THE INVENTION

It is, therefore, an object of the present invention to overcome the deficiencies of the prior art to include an interface device that will provide for functionality regardless of the type of touch technology currently in existence, including capacitive and resistive technology, may serve to increase the rigidity of the user interface where applicable, and may also provide for additional playability depending on the application.

In accordance with a disclosed exemplary embodiment, an interface enhancement component is described for use with touch devices. This component consists of a thin, rigidity increasing, generally flat-shaped support structure, no larger than the size of the user interface directly attached to the component. Disclosed embodiments provide a slight protrusion extending from the support structure. The protrusion consists of one of a gradually rising bell-shaped, oval or circular mound-shaped, or plateau-shaped structure that allows for accuracy of input and is angled in relation to the support structure for optimal application. The material comprising this component will provide for functionality regardless of the type of touch technology currently in existence, including capacitive and resistive technology, it may serve to increase the rigidity of the user interface where applicable, and it may provide for additional playability depending on the application.

There has thus been outlined, rather broadly, certain embodiments of the invention in order that the detailed description of the invention herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as in the abstract, are for the purpose of description and should not be regarded as limiting.

As such, those skilled in the art will appreciate that the concept upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The accompanying drawings, which are incorporated herein and constitute part of this specification, illustrate exemplary embodiments of the invention and, together with the detailed description given below, serve to explain the features of the invention.

FIGS. 1-4 illustrate various perspective views of the example component constructed in accordance with an embodiment of the invention;

FIG. 5 illustrates a front view of the example component of FIGS. 1-4 in accordance with an embodiment of the invention;

FIG. 6 illustrates a top view of the example component of FIGS. 1-4 in accordance with an embodiment of the invention;

FIG. 7 illustrates a side view of the example component of FIGS. 1-4 in accordance with an embodiment of the invention;

FIG. 8 illustrates a bottom view of the example component of FIGS. 1-4 in accordance with an embodiment of the invention;

FIG. 9 illustrates an exemplary closed packaging system for one or more component of FIGS. 1-4 in accordance with an embodiment of the invention;

FIG. 10 illustrates an open configuration of the exemplary packaging system of FIG. 9 in accordance with an embodiment of the invention;

FIG. 11 illustrates a perspective view of how an example component may be worn on both hands, on both the thumb and index fingers, in accordance with an embodiment of the invention;

FIG. 12 illustrates a close-up example of an alternative combination of an example component on the right hand that includes the use of both the index finger and the thumb in accordance with an embodiment of the invention;

FIG. 13 illustrates an example of a reusable component that uses an adhesive strip to attach the component to the finger in accordance with an embodiment of the invention;

FIG. 14 illustrates how an example component may be used in a glove pair scenario constructed in accordance with an embodiment of the invention;

FIG. 15 illustrates an alternative combination of an example component used in a right glove that includes the use of the index finger in accordance with an embodiment of the invention;

FIG. 16 illustrates an embodiment attached to the human thumbs in a typical scenario for interfacing with a handheld touch device; and

FIG. 17 illustrates an embodiment attached to the human index finger in a typical scenario for interfacing with a handheld touch device.

### DETAILED DESCRIPTION OF THE PREFERRED EMBODIMENTS

### Definitions

Where the definition of a term departs from the commonly used meaning of the term, applicant intends to utilize the definitions provided below, unless specifically indicated.

“Component” is used to describe the entire general embodiment of the invention article.

“User interface” is meant as the portion of the body used to manipulate the touch-based, touch-sensitive, or motion-sensitive device (hereinafter “touch device”) and which may make direct or indirect contact with the touch device.

A “touch-screen device” or “touch device” is meant to refer to an electronic visual display that can detect the presence and location of a touch within the display area. The term generally refers to touching the display of the device with a finger or hand. Touch screens can also sense other passive objects, such as a stylus. Touch screens are common in devices such as all-in-one computers, tablet computers, and smartphones. The touch screen has two main attributes. First, it enables a user to interact directly with what is displayed, rather than indirectly with a pointer controlled by a mouse or touch pad. Secondly, it lets a user do so without requiring any intermediate device that would need to be held in the hand. Such displays can be attached to computers, or to networks as terminals. They may also play a prominent role in the design of digital appliances such as personal digital assistants (PDAs), satellite navigation devices, mobile phones, and video games.

“Body” is meant as a general reference to an animate object as a whole and is not necessarily restricted to a human body.

### Description

The invention will now be described with reference to the drawing figures, in which like reference numerals refer to like parts throughout. The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

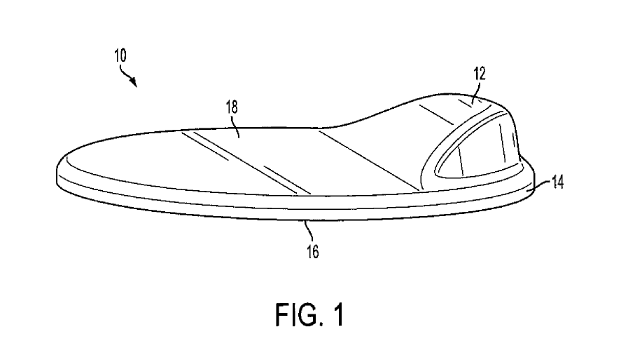

Turning to FIGS. 1-4, the present invention consists of an interface enhancement component 10 for use with touch devices, which may cover a portion of the surface of the user interface. This component 10 may be attached and positioned in a number of ways described below, with the specific manner of attachment and positioning to be ultimately determined by the preference of the user or the specific application of the invention article.

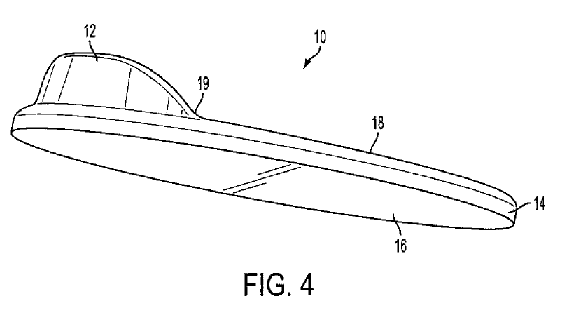

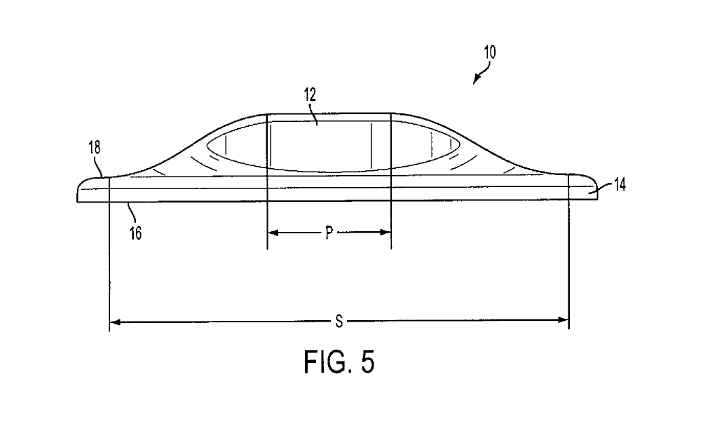

FIG. 7 shows a side view of the component 10, illustrating an example of the support structure 16 and its shape 18. The component 10 consists of: a support structure 16 and a protrusion 12. The support structure 16 may typically be comprised of a thin, relatively flat-shaped structure. A width “D” may be determined by the specific surface area of the user interface and should be no larger than the smallest user interface on the body, but it will typically fall between approximately 0.188″ (3 mm) and 0.394″ (10 mm) The minimum required width of the support structure 16 will support the protrusion 12 at a minimum of 3 mm. In some disclosed embodiments, an ideal shape of the support structure 16 consists of a circle. As shown, for example, in FIG. 8, a bottom view of component 10 illustrates a disclosed simplistic design of the support surface having center “C.” The circular shape allows for diverse positioning on the user interface.

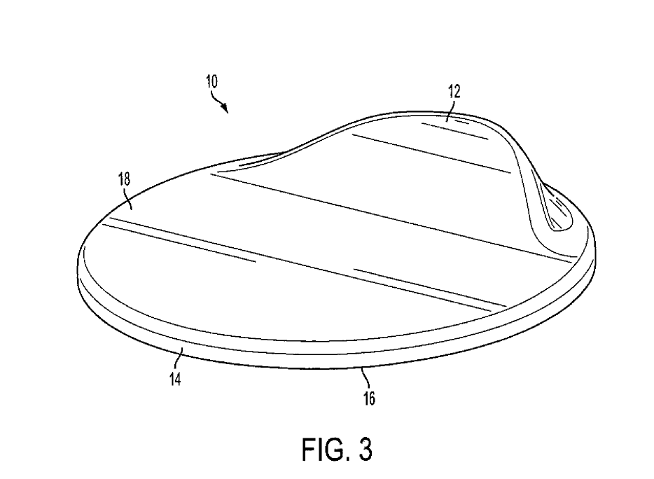

FIG. 6 illustrates a top view of the component 10 and edge 14 containing the protrusion 12 along with an example of the support structure 16 having shape 18. FIG. 7 also provides an illustration of the angle 19 of the protrusion 12 in relationship to the support structure 16. This angle 19 allows for the natural contact point of the protrusion onto the touch device, providing for accuracy with tasks such as typing. The overall simplicity of the design, including the shape 18, the location of the angle 19 of protrusion 12, the cross diameter “D” of the support structure 16, the total height “T” of the protrusion 12, the base thickness “t” of the support structure 16, and the general shape 18 of the support structure 16, allow the user to determine precisely where the component 10 will be most suitably attached for individual needs. In disclosed embodiments, the base thickness “t” is between approximately 0.008″ (0.2032 mm) and 0.02″ (0.508 mm)

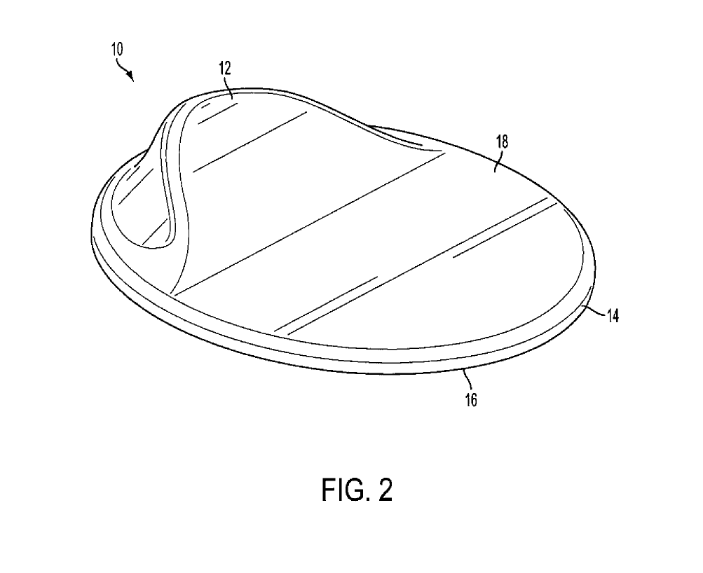

The protrusion 12 may typically be comprised of a bell-shaped curve, an oval or circular mound shape, or a plateau shape. The general advantages of these designs allow for a balance between accuracy and proximity resulting from the curved protrusion shape providing a gradual, well-defined surface area with which to engage the touch-screen device. FIG. 5 illustrates an example of a straight-on view of the component 10 and edge 14 containing the protrusion 12 along with an example of the depth of the support structure 16 and its shape 18. Referencing FIGS. 5, 6 and 7, the height of the protrusion 12 may be determined from a difference between the height “T” of the thickest point of protrusion shape (e.g., the bell-shaped curve oval/circular mound, or plateau shape) and the base thickness “t” of the support structure 16. In disclosed embodiments, the aforementioned height of the protrusion 12 is between approximately 0.0079″ (0.2 mm) and 0.0394″ (1 mm).

The angle 19 of protrusion 12 is in relation to the support structure 16 and is determined by the general shape of the protrusion used, the total volume comprising the protrusion and the height of the protrusion. The angle 19 typically consists of a slope between 2 and 45 percent, where the mound shape and bell shape tend to be on the lower end, whereas the plateau shape tends to be on the higher end of the aforementioned slope range.

In general, the protrusion 12 may be disposed anywhere along the shape 18 of component 10 in order to promote dexterity of the user interface. In selected embodiments, e.g., the embodiment depicted in FIG. 5, a width “S” of the protrusion 12 is formed generally from the shape 18 inwardly from side edges 14 of component 10. As shown in FIGS. 5 and 7, the protrusion 12 extends angularly from a base of the support surface 16 and rises in elevation to form a protrusion shape. As viewed in FIG. 7, the protrusion 12 is formed from a front edge of component 10. In this instance, a bell-shaped curve is formed; however, in other disclosed embodiments, another protrusion shape may be formed including, for example, an oval or circular mound shape or a plateau shape. A design of the top forward portion of the protrusion 12 may include a width “P” (FIG. 5). In disclosed embodiments, the width “S” may be approximately between 0.098″ (2.5 mm) and 0.374″ (9.5 mm); the width “P” may be approximately between 0.039″ (1 mm) and 0.276″ (7 mm) The protrusion 12 may be located anywhere on the support structure 16; however, the advantages of placement on and/or general extension from the outward edge 14 of the support structure 16 may maximize the dexterity of the user interface as illustrated, for example, in FIGS. 1-7.

The material comprising the component 10 will typically contain a substance allowing conductive properties. The core conductive properties relevant to the function of the material include surface resistivity (measured in ohms/square inch) and volume resistivity (measured in ohms/cm). A current method for altering the conductivity of suitable semiconductor materials involves a method of doping the material using substances such as silver, copper, stainless steel, stainless steel fiber, or a carbon donor such as carbon black, carbon fiber or other carbon-based material such as nickel coated carbon fibers, carbon nanotubes, and/or carbon nanofibers. This adds or increases electrical conductivity of the base material by decreasing the resistance to the flow of current across and through the material. In some instances, the component 10 may require playability, such as in various silicone materials; in other cases it may require a more rigid material such as a plastic or hybrid polymer. One advantage of silicon-based materials is the natural antibacterial properties of silicon, thus making the component 10 useful in many applications including extended-use and sterile environments. In a preferred embodiment, component 10 may be doped or modified from its original source material to increase the conductance (i.e., decrease the resistivity) thereof using a carbon-based filler. This increased conductance allows for proper reading from the touch device where capacitive touch technology is utilized. The ideal overall resistivity of the resulting silicon or polymer material should have a surface resistivity less than 10E5 ohm and a volume resistivity of less than 10e4 ohm/cm. This ensures a sufficient level of current to flow from the user interface through the component 10 material to the touch-screen device.

The consideration of one of several plastic materials that may be utilized in disclosed embodiments of the component 10 may include characteristics relevant to the “stiffness” of the plastic material. While this may be measured in many ways, the one considered in the present application is the durometer measured in shore type “A”. Embodiments for the present application may include durometer measurements of the plastic material approximately between 70 shore A and 90 shore A. Depending on the type of plastic that is used, the ideal hardness may vary. Additionally, the disclosed properties of the plastic are designed to adhere well to an adhesive that may be applied to a surface of the component 10, as discussed below.

In one instance of the component 10 application, the user interface surface is the pad of the thumb; the hand is the right and/or the left hand, and the corresponding touch interface of a personal digital assistant (PDA) device is being operated with either or both hands, with the thumbs being used as the user interface. The user determines the exact positioning of the component 10 such that the protrusion 12 suits the user's preference for comfortable contact with the touch device.

In another instance of the component 10 application, the user interface surface is the pad of the index finger, the hand is either or both and the corresponding touch device interface is that of a tablet PC operated with either or both hands. The user determines the exact positioning of the component 10 such that the protrusion 12 suits the user's preference for comfortable interaction with the touch device.

In another instance of the application, the surface is the exterior surface of a glove at the position of the pad of the thumb and the index fingers, located on either hand in the pair, and the component 10 is built into the construction of the glove at a position optimal for use of touch devices. This application may require a glove pair, or a left and a right version of the glove.

In another instance of the application, the component 10 is built into the construction of latex or latex-free protective gloves at a position optimal for comfortable use of touch devices without interruption of normal functions. This application would be for use in a sterile environment such as an operating room or when dealing with medical, mechanical or other scenarios involving the simultaneous use of protective gloves and touch-manipulated equipment. This application may require a glove pair, or a left and a right version of the protective glove.

In embodiments that do not include the component 10 being built into an item's structure such as a glove, the application of the component 10 would typically consist of a temporary or semi-temporary bonding of the component 10 to the surface through the use of a pre-applied pressure-sensitive bonding agent safe for contact with the user interface; or, in the embodiment of a reusable component 10, an additional double-sided pressure-sensitive bonding layer can be applied between the inside component 10 surface and the user interface at time of application. (For examples of potential adhesive methods, see: 20060251892, Husemann, Anti-static self-adhesive strip, 2006; 7097903, Kishioka and Ohura, Double-sided pressure-sensitive adhesive sheet and method for sticking and fixing touch panel to display device, 2006; 2804073, Gallienne, Fluid Surgical Dressing, 1957; 5556636, Yano, Takeo and Hidaka, Adhesive composition for medical use, 1996; 4665127, Hirose and Isayama, Pressure sensitive adhesive composition, 1987.) These documents are hereby incorporated by reference.

FIGS. 1-4 illustrate various views showing an example of the general support structure 16 along with the angled protrusion 12 running along a portion of the outward edge 14 of the support structure 16 that makes up the entirety of the component 10. The protrusion 12 extends generally upwardly from a base of the support surface 16. In disclosed embodiments, the extension of the protrusion 12 from the base of the support surface 16 may occur angularly. The support structure 16 is large enough to provide the level of support required to enable the protrusion 12 to interface with the touch device while maintaining stability. The general shape of the support structure 16 is preferably lens shaped; however, this is not necessary as long as it provides enough broad support for the protrusion 12. Additionally, this support structure 16 may be used to interface with the touch device as well as with other interfaces, such as physical buttons on a keyboard.

FIGS. 1-4 illustrate an example of the relatively flat shape 18 of support structure 16. In some embodiments, the shape 18 may be altered, as necessary, for example, to accommodate selective shapes of a user interface. For example, the shape 18 may include a concave meniscus shape of the support structure 16. The depth of the concave meniscus may be sufficient to provide a comfortable, secure fit once the component 10 is attached to the user interface. Typical depth may range from 250 micrometers to 1 millimeter in the described embodiment.

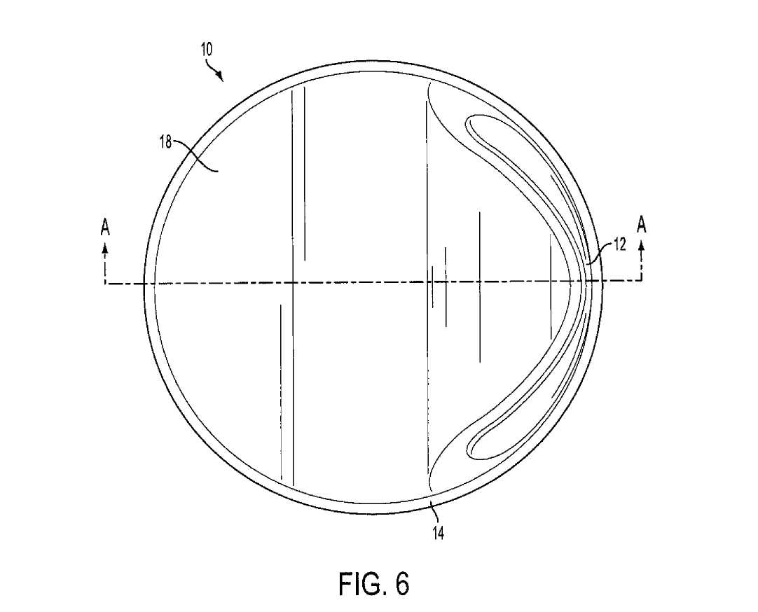

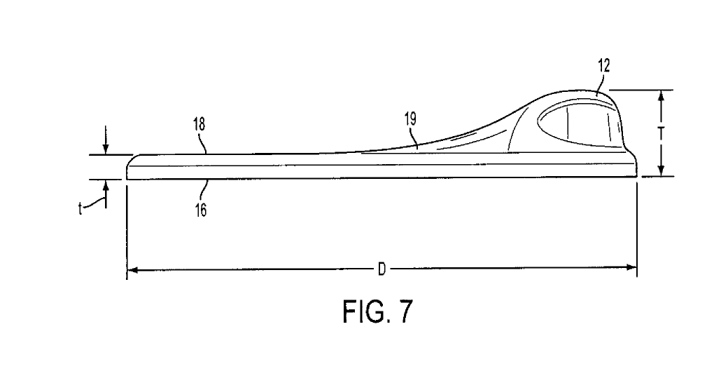

FIG. 9 illustrates one embodiment for packaging one or more components 10. By way of example, the package may comprise a foldable container 38. Turning to FIG. 10, the foldable container 38 is opened by separating a top flap 44 from a bottom flap 42. Top flap 44 and bottom flap 42 may be originally connected to one another in order to protect and secure one or more components 10 disposed therein. For example, in one disclosed embodiment, flaps 42, 44 are adhesively secured. A disclosed configuration provides the one or more components 10 adhesively secured to an adhesive backing 40 disposed within container 38, for example, along bottom flap 42. Component 10 is easily removed from backing 40 simply by peeling the component 10 from the backing 40. The adhesion is sufficiently applied to component 10 such that it may be reapplied to the backing for reuse and storage as necessary. While a foldable container 38 has been described in the present embodiment, it should be appreciated that any suitable container may be utilized for delivering, transporting, storing and/or protecting one or more components 10 in an appropriate use.

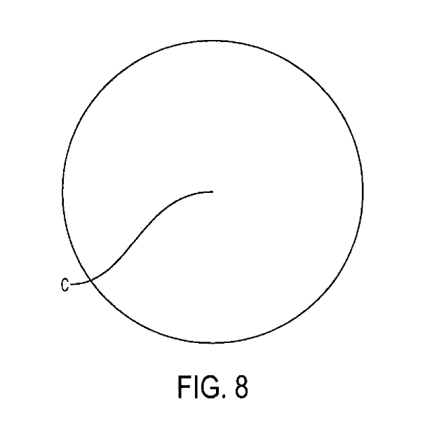

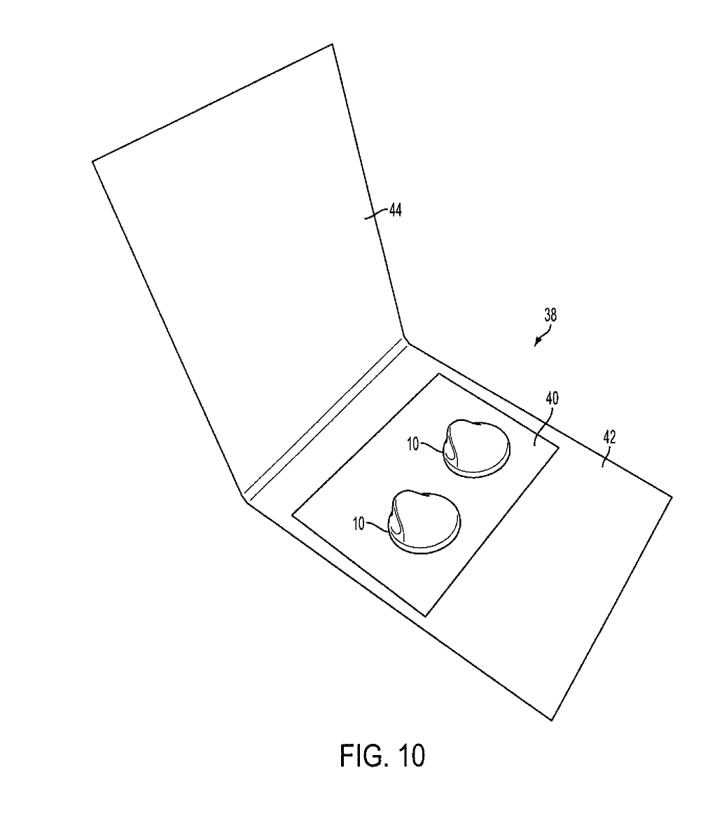

FIG. 11 is a perspective view of the left hand 22 and right hand 23, with the left thumb 28 and right thumb 30 pointing toward the viewer. This view also shows the left index finger 24 and right index finger 26, with a portion of the support structure 16 of the component 10 in view on either finger. It should be appreciated that any digit may be utilized with the teachings of the present invention. On the left and right thumbs, one may see the support structure 16 of the component 10 along with an example of the position of the protrusion 12 directed slightly toward the index finger of the same hand. In this example, the component 10 is attached to the user interface with an adhesive bonding agent that is pre-applied to a surface of the support structure 16. The type of adhesive may be selected to allow sufficient re-application of the component 10 for re-use, or in a disposable scenario. Alternatively, an adhesive may be applied to either the surface or the component 10 prior to attaching the component 10 to the user interface in a scenario, for example, in which the component 10 is reusable, and the adhesive bonding agent is a double-sided bonding layer 32, such as that shown in FIG. 13.

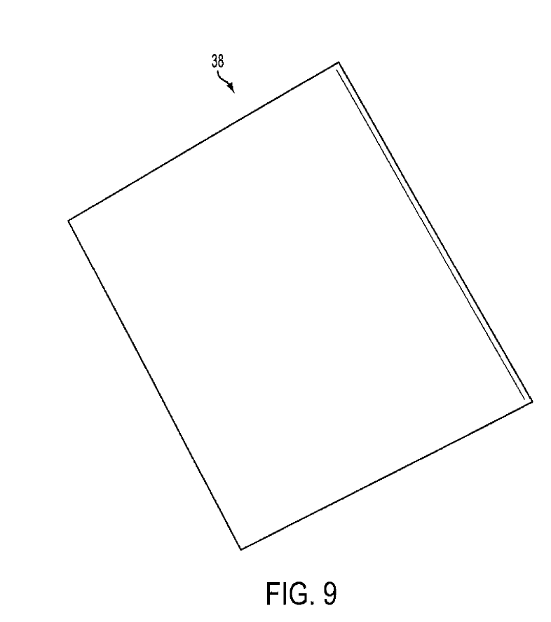

FIG. 12 is an example of an isolated view of the right hand 23 where the component 10 is located on both the right index finger 26 and the right thumb 30. The protrusion 12 of the component 10 attached to the index finger is positioned towards the side closest to the middle finger and at a suitable location on the pad of the fingertip for the user to comfortably use the index finger to interface with the touch device. Additionally, the support structure 16 of the component 10 is positioned with the protrusion 12 on the outside edge of the right thumb 30 pointing away from the right index finger 26.

FIG. 13 is an example of the component 10 that represents a reusable version which requires the use of a thin, double-sided bonding layer 32 to act as a temporary adhesive layer. This bonding layer 32 would be applied each time the user wants to attach the component 10 to the user interface.

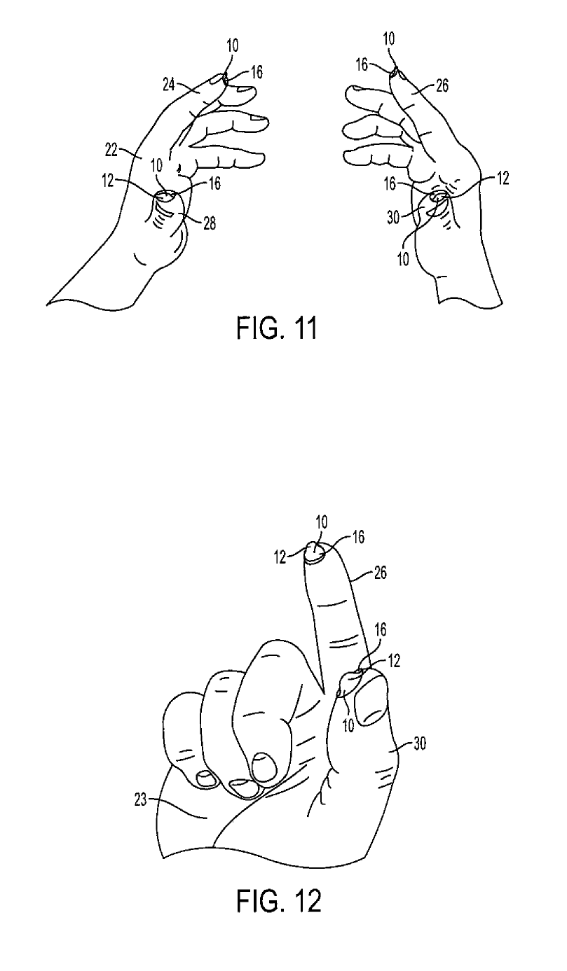

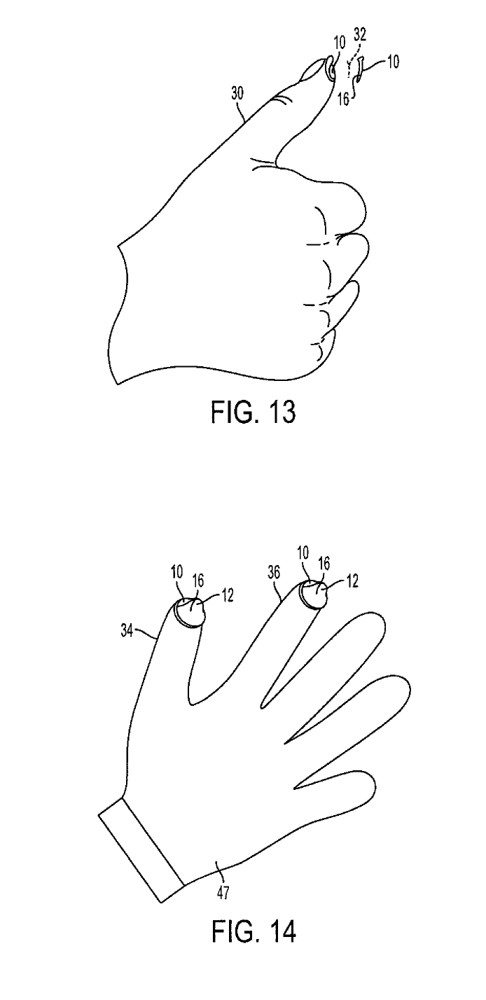

FIGS. 14-15 illustrate disclosed embodiments for how the component 10 could be integrated into a glove. Ideal placement of the support structure 16 of the component 10 would be similar to how it is pictured, where the protrusion 12 of the component 10 located in the thumb position 34 is pointing toward the index finger, and likewise the protrusion 12 located in the index finger position 36 is pointing toward the middle finger. A portion of the support structure 16 of the component 10 would extend through the material that comprises the glove to make contact with the finger, which enables the necessary conductive path for capacitive touch devices. The disclosed configurations allow the user to manipulate components of their electronic device including, for example, buttons and the touch screen, without exposing protected digits to environmental elements such as cold, wet or windy weather. In this manner, the user is allowed to effectively and accurately control their electronic device to perform serviceable operations including, for example, making telephone calls, sending e-mails, instant messaging, texting, tweeting, playing music, etc.

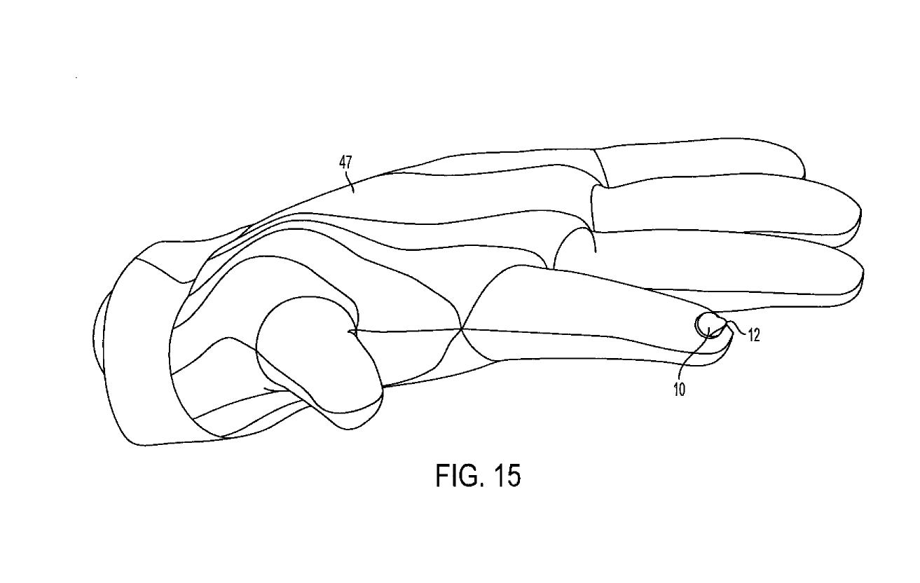

FIG. 16 illustrates how the component 10 can be positioned on the thumbs to interface comfortably with a touch device 45. The protrusion 12 is positioned slightly inward toward the index finger, allowing for natural positioning of typical contact between the user interface and the touch device. In this illustration, only the protrusion 12 is visible.

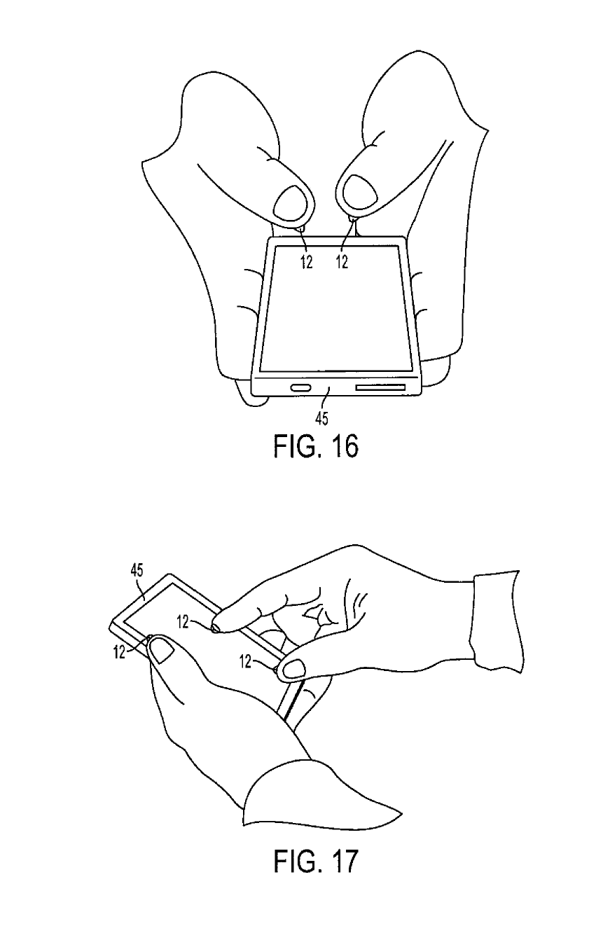

FIG. 17 illustrates how the component 10 may, in addition, be positioned on the index finger to interface comfortably with a touch device 45. The protrusion 12 is positioned slightly toward the middle finger on the tip of the index finger. In this illustration, both the protrusion 12 and a portion of the support structure of the component on the index finger are visible.

The component 10 may be manufactured using any number of molding and forming methods suitable for cost targets, the materials used and whether the application is disposable or re-usable. Ideal methods of manufacture include compression molding and injection molding; however, there may be additional molding processes, depending on the application, which better determine suitable manufacture. The materials required for manufacturing the component 10 may range from various forms of plastics to silicone- and rubber-based materials. These materials will be suitably doped to provide for sufficient capacitance of at least 1 to 3 pF (picofarad). The materials will be approved for use in direct, prolonged periods of contact with user interface types. The component 10 may be manufactured in multiple sizes, such as small, medium and large, to fit individual user interface features. The disposable embodiment of the component 10 will have material properties that allow for an individual to trim the support structure 16 to the desired size and shape as needed.

The final material to manufacture the component 10 will be the application of an adhesive bonding agent to the internal facing surface, which may be accomplished during the fabrication process, or through the creation of a double-sided bonding strip to be applied to a reusable embodiment at the time of component 10 application. In some disclosed embodiments, the adhesive may include a medical-grade adhesive, being either a transfer adhesive or a double-sided adhesive with a polyester liner of less than 3 mil thickness. In this case, the adhesive is preferably hypoallergenic and moisture resistant and will also possess an aggressive level of adhesion.

Having described the many embodiments of the present invention in detail, it will be apparent that modifications and variations are possible without departing from the spirit and scope of the invention. Furthermore, it should be appreciated that all examples in the present disclosure, while illustrating many embodiments of the invention, are provided as non-limiting examples and are, therefore, not to be taken as limiting the various aspects so illustrated.

While the present invention has been disclosed with references to certain embodiments, numerous modifications, alterations and changes to the described embodiments are possible without departing from the spirit and scope of the present invention, as defined in the appended claims. Accordingly, it is intended that the present invention not be limited to the described embodiments, but that it has the full scope defined by the language of the following claims and equivalents thereof

Please incorporate the following documents by reference: U.S. Pat. Nos. 3,048,149; 6,533,480; D487,896; U.S. Pat. Nos. 6,225,988; 5,453,759; 6,249,277; 2005/0093835; D618,243; 2008/0106521; 2007/0013681; D570,915; 2008/0297493; 2009/0303187; 2005/0057493; 2009/0184927; U.S. Pat. Nos. 6,141,643; 5,581,484; 2009/0289,893; U.S. Pat. No. 7,844,914; 2009/0284471; U.S. Pat. No. 5,880,712; and 2006/0221066.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless such changes and modifications depart therefrom.

What is claimed is:

1. An interface component comprising:
a support structure configured to attach to a user interface; and
a protrusion extending from a base of the support structure, wherein the support structure and protrusion comprise a material that allows conductive properties from the user through the component.

2. The component of claim 1, wherein the component includes an adhesive bonded to the support surface for attaching to the user interface.

3. The component of claim 2, wherein the adhesive includes a double-sided bonding strip.

4. The component of claim 2, wherein the adhesive includes a medical-grade adhesive, being either a transfer adhesive or double-sided adhesive.

5. The component of claim 2, wherein the adhesive includes a polyester liner.

6. The component of claim 5, wherein the polyester liner is less than 3 mil thick.

7. The component of claim 1, wherein the material provides a capacitance of 1 to 3 pF (picofarad).

8. The component of claim 1, wherein the material is made from one of a silicon-based material, a plastic and a hybrid polymer.

9. The component of claim 1, wherein the stiffness of the material is between approximately 70 shore A and 90 shore A.

10. The component of claim 1, wherein a surface resistivity of the material is less than 10E5 ohm.

11. The component of claim 1, wherein a volume resistivity of the material is less than 10e4 ohm/cm.

12. The component of claim 1, wherein the material is doped using one or more materials selected from a carbon based filler, silver, copper, stainless steel, stainless steel fiber, or a carbon donor such as carbon black, carbon fiber or other carbon-based material such as nickel coated carbon fibers, carbon nanotubes, and/or carbon nanofibers.

13. The component of claim 1, wherein the support structure is adjustable to fit a desired size and shape of the user interface.

14. The component of claim 1, wherein the support structure is configured to be maneuverable to fit one of multiple positions disposed upon the user interface.

15. The component of claim 1, wherein the support structure includes an edge and the protrusion is formed from the edge.

16. The component of claim 1, wherein the support structure extends angularly from the base of the support structure and rises in elevation to form a protrusion shape.

17. The component of claim 16, wherein the protrusion shape comprises one of a bell-shaped curve, an oval or circular mound shape, or a plateau shape.

18. The component of claim 16, wherein the height of the protrusion is between approximately 0.0079″ (0.2 mm) and 0.0394″ (1 mm)

19. The component of claim 16, wherein the angle of the protrusion shape consists of a slope between 2 and 45 percent.

20. The component of claim 16, wherein the base of the support structure comprises a thickness between approximately 0.008″ (0.2032 mm) and 0.02″ (0.508 mm)

21. The component of claim 16, wherein the width of the support structure is between approximately 0.188″ (3 mm) and 0.394″ (10 mm)

22. An interface component for use with touch devices comprising:
a support structure configured to attach to a user interface; and
a protrusion extending from a base and formed from an edge of the support structure, wherein the support structure and protrusion comprise materials that allow conductive properties from the user through the component.

23. An interface component comprising:
a support structure configured to attach to a user interface; and
a protrusion extending from a base and formed from an edge of the support structure,
wherein the support structure and protrusion comprise materials that allow conductive properties from the user through the component,
wherein the height of the protrusion is between approximately 0.0079″ (2 mm) and 0.0394″ (1 mm),
wherein the base of the support structure comprises a thickness between approximately 0.008″ (0.2032 mm) and 0.02″ (0.508 mm),
wherein the width of the support structure is between approximately 0.188″ (3 mm) and 0.394″ (10 mm),
wherein a surface resistivity of the material is less than 10E5 ohm,
wherein a volume resistivity of the material is less than 10e4 ohm/cm,
wherein the stiffness of the material is between approximately 70 shore A and 90 shore A,
wherein the material provides a capacitance of 1 to 3 pF (picofarad),
wherein the angle of the protrusion shape consists of a slope between 2 and 45 percent.

24. An interface component comprising:
a support structure configured to attach to a user interface; and
a protrusion angularly extending from a base and formed from an edge of the support structure,
wherein the support structure and protrusion comprise materials that allow conductive properties from the user through the component,
wherein the height of the protrusion is between approximately 0.0079″ (2 mm) and 0.0394″ (1 mm),
wherein the base of the support structure comprises a thickness between approximately 0.008″ (0.2032 mm) and 0.02″ (0.508 mm),
wherein the width of the support structure is between approximately 0.188″ (3 mm) and 0.394″ (10 mm),
wherein the angle of the extended protrusion consists of a slope between 2 and 45 percent.

25. An interface component comprising:
a support structure configured to attach to a user interface; and
a protrusion extending from a base and formed from an edge of the support structure,
wherein the support structure and protrusion comprise materials that allow conductive properties from the user through the component,
wherein a surface resistivity of the material is less than 10E5 ohm,
wherein a volume resistivity of the material is less than 10e4 ohm/cm,
wherein the material provides a capacitance of 1 to 3 pF (picofarad).
